(19) United States
(12) Patent Application Publication
(10) Pub. No.: US 2024/0290603 A1
(43) Pub. Date: Aug. 29, 2024

(54) MASS SPECTROMETER AND MASS SPECTROMETRY METHOD USING THE SAME

(71) Applicant: YOUNG IN ACE Co., Ltd., Gyeonggi-do (KR)

(72) Inventors: Sungwon KANG, Gyeonggi-do (KR); Seontae KIM, Gyeonggi-do (KR); Hun LEE, Gyeonggi-do (KR); Yoon Jin JEONG, Gyeonggi-do (KR); Hyunsang LEE, Gyeonggi-do (KR); Nam Seok LEE, Gyeonggi-do (KR)

(21) Appl. No.: 18/581,448

(22) Filed: Feb. 20, 2024

(30) Foreign Application Priority Data
Feb. 28, 2023 (KR) 10-2023-0027162

(51) Int. Cl. H01J 49/24; H01J 49/04; H01J 49/42

(52) U.S. Cl. CPC H01J 49/24; H01J 49/0495; H01J 49/4215

(57) ABSTRACT

Provided is a mass spectrometer including: an upper region providing an upper flow path; a lower region providing a lower flow path; a reaction tube providing a reaction passage connecting the upper flow path and the lower flow path; a first turbo pump coupled to the upper region to apply vacuum pressure to the upper flow path; a second turbo pump coupled to the lower region to apply the vacuum pressure to the lower flow path; and a main pump. Here, the main pump is connected to: the first turbo pump and connected to the upper flow path through the first turbo pump; the second turbo pump and connected to the lower flow path through the second turbo pump; and the reaction passage to apply the vacuum pressure to the reaction passage.

### CROSS-REFERENCE TO RELATED APPLICATIONS

This U.S. non-provisional patent application claims priority under 35 U.S.C. § 119 of Korean Patent Application No. 10-2023-0027162, filed on Feb. 28, 2023, the entire contents of which are hereby incorporated by reference.

### BACKGROUND

The present disclosure herein relates to a mass spectrometer and a mass spectrometry method using the same, and more particularly, to a mass spectrometer capable of reducing a volume and a mass spectrometry method using the same.

As pollution of air and water containing fine dust is accelerated, a method for measuring and analyzing the pollution is required. A mass spectrometer may be used for the method for measuring and analyzing the pollution.

The mass spectrometer is an instrument for identifying or analyzing a chemical agent through the mass spectrometry. The mass spectrometer may analyze constituents of a sample by measuring a mass-to-charge ratio of a material. The mass spectrometer may use various methods to ionize the sample. The ionized sample may be accelerated while passing through an electric field and/or a magnetic field. That is, a path of a portion or a whole of the ionized sample may be deflected by the electric field and/or the magnetic field. A detector may detect the ionized sample.

### SUMMARY

The present disclosure provides a mass spectrometer capable of reducing a total volume and a mass spectrometry method using the same.

The present disclosure also provides a mass spectrometer capable of individually controlling pressure and a mass spectrometry method using the same.

The present disclosure provides a mass spectrometer capable of controlling various variables and a mass spectrometry method using the same.

The object of the present invention is not limited to the aforesaid, but other objects not described herein will be clearly understood by those skilled in the art from descriptions below.

An embodiment of the inventive concept provides a mass spectrometer including: an upper region configured to provide an upper flow path; a lower region configured to provide a lower flow path; a reaction tube configured to provide a reaction passage configured to connect the upper flow path and the lower flow path; a first turbo pump coupled to the upper region to apply vacuum pressure to the upper flow path; a second turbo pump coupled to the lower region to apply the vacuum pressure to the lower flow path; and a main pump, wherein the main pump is connected to: the first turbo pump and connected to the upper flow path through the first turbo pump; the second turbo pump and connected to the lower flow path through the second turbo pump; and the reaction passage to apply the vacuum pressure to the reaction passage.

In an embodiment, the mass spectrometer may further include a connection tube configured to connect the reaction tube and the main pump, in which the main pump may be connected to the reaction passage through a connection passage provided by the connection tube.

In an embodiment, the mass spectrometer may further include a regulation valve disposed on the connection tube.

In an embodiment, the regulation valve may include a solenoid valve.

In an embodiment, the upper region may include: an ion generation part configured to provide an ion generation passage; and an ion selection part connected to the ion generation passage to provide an ion selection passage, in which the ion generation passage and the ion selection passage may be a portion of the upper flow path, and the first turbo pump may be coupled to the ion selection part.

In an embodiment, the ion selection part may include a first quadrupole filter disposed in the ion selection passage.

In an embodiment, the upper region may further include a carrier gas inlet part disposed between the ion selection part and the reaction tube.

In an embodiment, the mass spectrometer may further include a sample inlet tube coupled to the reaction tube to provide a sample inlet passage connected to the reaction passage.

In an embodiment, the lower region may include: a second ion selection part configured to provide a second ion selection passage connected to the reaction passage; and an ion detection part coupled to the second ion selection part, in which the second ion selection passage may a portion of the lower flow path, and the second turbo pump may be coupled to the second ion selection part.

In an embodiment, the ion detection part may include an ion detector, and the ion detector may be exposed to the second ion selection passage.

In an embodiment of the inventive concept, a mass spectrometer includes: an ion generation part configured to provide an ion generation passage; an ion selection part connected to the ion generation passage to provide an ion selection passage; a reaction tube configured to provide a reaction passage connected to the ion selection passage; a second ion selection part configured to provide a second ion selection passage connected to the reaction passage; an ion detection part coupled to the second ion selection part; a first turbo pump coupled to the ion selection part to apply vacuum pressure to the ion selection passage; a second turbo pump coupled to the second ion selection part to apply the vacuum pressure to the second ion selection passage; a main pump connected to the reaction tube to apply the vacuum pressure to the reaction passage; and a regulation valve disposed between the reaction tube and the main pump.

In an embodiment, the mass spectrometer may further include a connection tube configured to connect the reaction tube and the main pump, in which the regulation valve may be disposed on the connection tube.

In an embodiment, the regulation valve may include a solenoid valve.

In an embodiment, the main pump may be connected to the first turbo pump to apply the vacuum pressure to the ion selection passage through the first turbo pump.

In an embodiment, the main pump may be connected to the second turbo pump to apply the vacuum pressure to the second ion selection passage through the second turbo pump.

In an embodiment of the inventive concept, a mass spectrometry method includes: generating and selecting ions in an upper region; moving the ions selected in the upper region to a reaction tube; supplying a sample gas to the reaction tube; moving a fluid in the reaction tube to a lower region; and detecting the ions in the lower region, in which the moving of the ions selected in the upper region to the reaction tube includes: applying vacuum pressure to the reaction tube by using a main pump connected to the reaction tube; and adjusting pressure of the reaction tube by using a regulation valve disposed between the reaction tube and the main pump.

In an embodiment, the generating and selecting of the ions in the upper region may include applying the vacuum pressure to the upper region by using a first turbo pump, and the first turbo pump may be connected to the main pump.

In an embodiment, the moving of the fluid in the reaction tube to the lower region may include applying the vacuum pressure to the lower region by using a second turbo pump, and the second turbo pump may be connected to the main pump.

The object of the present invention is not limited to the aforesaid, but other objects not described herein will be clearly understood by those skilled in the art from descriptions below.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a schematic view illustrating a mass spectrometer according to embodiments of the inventive concept;

FIG. 2 is a cut-away perspective view illustrating the mass spectrometer according to embodiments of the inventive concept;

FIG. 3 is a flowchart representing a mass spectrometry method according to embodiments of the inventive concept;

FIG. 4 is a cut-away perspective view illustrating the mass spectrometer that performs the mass spectrometry method according to the flowchart of FIG. 3;

FIG. 5 is a graph showing a portion of results obtained by performing the mass spectrometry method using the mass spectrometer according to embodiments of the inventive concept; and

FIG. 6 is a schematic view illustrating a mass spectrometer according to embodiments of the inventive concept.

### DETAILED DESCRIPTION

Embodiments of the inventive concept will be described with reference to the accompanying drawings so as to sufficiently understand constitutions and effects of the present invention. The technical ideas of the inventive concept may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims.

Like reference numerals refer to like elements throughout. The embodiment in the detailed description will be described with cross-sectional views and/or plan views as ideal exemplary views of the inventive concept. Also, in the figures, the dimensions of layers and regions are exaggerated for clarity of illustration. Areas exemplified in the drawings have general properties, and are used to illustrate a specific shape of a semiconductor package region. Thus, this should not be construed as limited to the scope of the present invention. Also, although various terms are used to describe various components in various embodiments of the inventive concept, the component are not limited to these terms. These terms are only used to distinguish one component from another component. Embodiments described and exemplified herein include complementary embodiments thereof.

In the specification, the technical terms are used only for explaining a specific exemplary embodiment while not limiting the present invention. In the specification, the terms of a singular form may include plural forms unless referred to the contrary. Also, the meaning of “include,” “comprise,” “including,” or “comprising,” specifies a property, a region, a fixed number, a step, a process, an element and/or a component but does not exclude other properties, regions, fixed numbers, steps, processes, elements and/or components.

Hereinafter, preferred embodiments of the inventive concept will be described in detail with reference to the attached drawings.

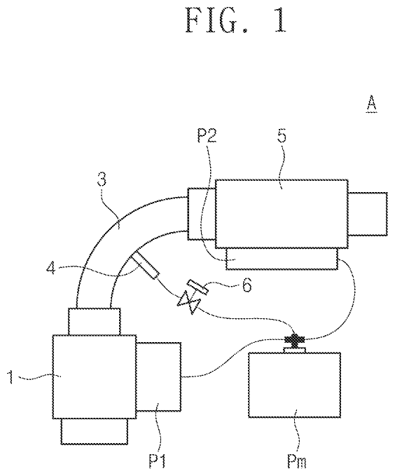

FIG. 1 is a schematic view illustrating a mass spectrometer according to embodiments of the inventive concept.

Referring to FIG. 1, a mass spectrometer A may be provided. The mass spectrometer A may detect a specific constituent in a fluid. For example, the mass spectrometer A may analyze a volatile organic compound (VOC) in the air. To this end, the mass spectrometer A may ionize a portion of a sample gas and analyze the ionized sample. That is, the mass spectrometer A may include a selected ion flow tube mass spectrometry (SIFT-MS). The mass spectrometer A may include an upper region 1, a reaction tube 3, a lower region 5, a first turbo pump P1, a second turbo pump P2, a main pump Pm, a connection tube 4, and a regulation valve 6.

The upper region 1 may provide an upper flow path (not shown). A fluid may flow in the upper flow path. The upper region 1 may generate and select ions. More specifically, the upper region 1 may generate the ions from an ion source. The ion source may represent particles that is convertible into the ions. More specifically, the ion source may represent particles that is convertible into the ions through an ionization reaction. Reagent ions may represent ions that react with the sample gas. The ion source may include neutral molecules. For example, the ion source may include nitrogen (N₂), oxygen (O₂), and/or water (H₂O). However, the embodiment of the inventive concept is not limited thereto. The generated reagent ions may be filtered. That is, only necessary ions may be selected from the generated ions and pass into a reaction tube 3. A carrier gas may be introduced through the upper region 1. The carrier gas may guide a movement direction of the fluid in one direction. The selected reagent ions and/or carrier gas may be moved into the reaction tube 3. More detailed description on the upper region 1 will be described later.

The reaction tube 3 may provide a reaction passage (not shown). The reaction passage may be connected to the upper flow path. The reaction tube 3 may move reactant ions and/or carrier gas introduced from the upper region 1 into the lower region 5. The sample gas may be supplied to the reaction tube 3. The sample gas may include an object that requires a mass spectrometry. For example, the sample gas may include volatile organic compounds (VOCs). The sample gas introduced into the reaction tube 3 may react with the reagent ions. More specifically, the sample gas may be ionized by reacting with reagent ions. The ionized sample gas may be referred to as sample ions. That is, the sample gas may be converted into the sample ions by reacting with the reagent ions. The ionization reaction of the sample gas may be expressed as follows

R++A->P++N

Here, R+ may represent the reagent ions, A may represent the sample gas, P+ may represent the sample ions, and N may represent a state in which the reagent ions are neutralized after reaction with the sample gas. For example, N may represent the ion source that is neutralized again. The reaction tube 3 may be bent into a curve. For example, the reaction tube 3 may be bent at 90° as illustrated in FIG. 1. However, the embodiment of the inventive concept is not limited thereto.

The lower region 5 may provide a lower flow path (not shown). A fluid may flow in the lower flow path. The lower flow path may be connected to the reaction passage. The lower region 5 may select a portion of the ions. The lower region 5 may detect the selected ions. That is, the lower region 5 may detect a portion of the ions introduced from the reaction tube 3. Accordingly, a concentration of a specific material in the sample gas may be measured. A detailed description on the lower region 5 will be described later.

The first turbo pump P1 may be coupled to the upper region 1. The first turbo pump P1 may apply vacuum pressure to the upper region 1. That is, the first turbo pump P1 may apply the vacuum pressure to the upper flow path. Accordingly, the upper flow path may be maintained at a low pressure state. For example, the upper flow path may be maintained at about 10⁻⁵ torr. To this end, the first turbo pump P1 may include a vacuum pump. An additional pump may be connected in series for driving a second turbo pump P2. A detailed description thereof will be described later.

The second turbo pump P2 may be coupled to the lower region 5. The second turbo pump P2 may apply the vacuum pressure to the lower region 5. That is, the second turbo pump P2 may apply the vacuum pressure to the lower flow path. Accordingly, the lower flow path may be maintained at a low pressure state. For example, the lower flow path may be maintained at about 10⁻⁶ torr to 10⁻⁷ torr. To this end, the second turbo pump P2 may include a vacuum pump. An additional pump may be connected in series for driving the second turbo pump P2. A detailed description thereof will be described later.

The main pump Pm may be connected to the reaction tube 3. For example, the main pump Pm may be connected to the reaction tube 3 through the connection tube 4. The main pump Pm may apply the vacuum pressure to the reaction tube 3. The main passage may be maintained at about 10⁻¹ torr to 10⁻² torr by the main pump Pm. The main pump Pm may have an output scale suitable to apply the vacuum pressure. In embodiments, the main pump Pm may be connected to each of the first turbo pump P1 and/or the second turbo pump P2. The main pump Pm may assist a function of the first turbo pump P1. That is, the first turbo pump P1 may make pressure in the upper flow path to a required level by the main pump Pm. Also, the main pump Pm may assist a function of the second turbo pump P2. That is, the second turbo pump P2 may make pressure in the lower flow path to a required level by the main pump Pm. A detailed description thereof will be described later.

The connection tube 4 may connect the main pump Pm and the reaction tube 3. The vacuum pressure may be applied from the main pump Pm to the reaction passage by the connection tube 4. A detailed description thereof will be described later.

The regulation valve 6 may be disposed on the connection tube 4. The regulation valve 6 may control the vacuum pressure applied from the main pump Pm to the reaction passage. For example, the regulation valve 6 may include an automatic valve. That is, the regulation valve 6 may include a solenoid valve. However, the embodiment of the inventive concept is not limited thereto. A detailed description on the regulation valve 6 will be described later.

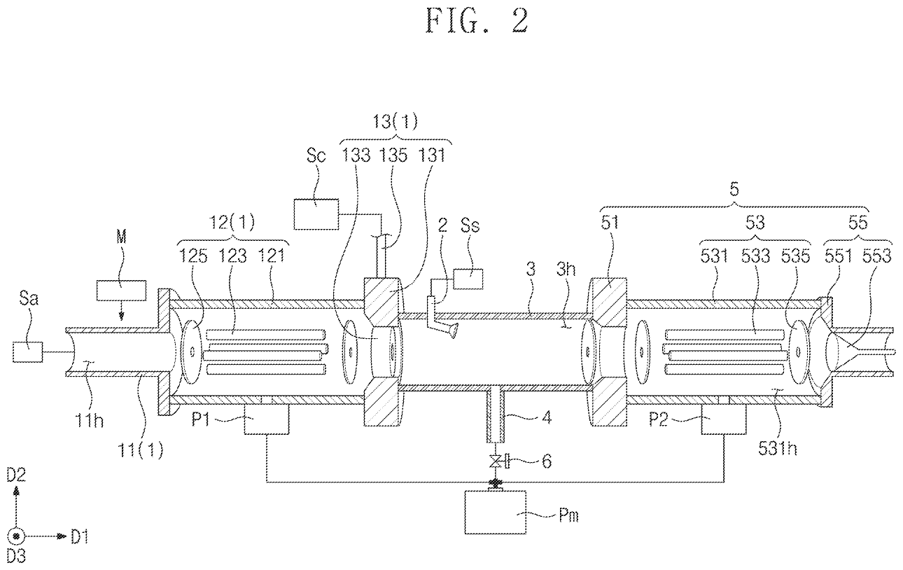

Although it is illustrated and described above that the reaction tube 3 is bent into a curve, the embodiment of the inventive concept is not limited thereto. For example, the reaction tube 3 may extend linearly. Hereinafter, an embodiment in which the reaction tube 3 extends linearly will be described with reference to FIG. 2.

FIG. 2 is a cut-away perspective view illustrating the mass spectrometer according to embodiments of the inventive concept.

Referring to FIG. 2, the upper region 1 may include an ion generation part 11, an ion selection part 12, and a carrier gas inlet 13.

The ion generation part 11 may provide an ion generation passage 11h. The ion generation passage 11h may be a portion of the above-described upper flow path. For example, the ion generation part 11 may have a tube shape extending in a first direction D1. The ion source supplied from an ion source supply part Sa may be moved to the ion generating part 11. The ion source may include oxygen (O₂), nitrogen (N₂), and/or water (H₂O). In embodiments, the ion source supplied from the ion source supply part Sa to the ion generation part 11 may have constituents similar to that of the air. However, the embodiment of the inventive concept is not limited thereto. The ion source in the ion generation passage 11h may be ionized by a microwave applied from the microwave supply part M. That is, the ion source may be ionized and converted into the reagent ions.

The ion selection part 12 may include an ion selection tube 121, a first quadrupole filter 123, and a first focusing member 125.

The ion selection tube 121 may provide an ion selection passage (not shown) extending in the first direction D1. The ion selection passage may be a portion of the above-described upper flow path. The ion selection passage may be connected to the ion generation passage 11h. The first turbo pump P1 may be fixed and coupled to the ion selection part 12. The first turbo pump P1 may apply the vacuum pressure to the ion selection passage.

The first quadrupole filter 123 may include four rods surrounding a path of reagent ions passing through the first focusing member 125. Each of the four rods may extend in the first direction D1. Each of the four rods may include metal. Each of the four rods may receive a voltage from an external power supply (not shown). The first quadrupole filter 123 may form an electric field. A movement path of a portion or a whole of the reagent ions may be bent by the electric field formed by the first quadrupole filter 123.

The first focusing member 125 may be disposed at the first ion selection passage. The first focusing member 125 may have a plate shape having a hole formed at a center thereof. The first focusing member 125 may guide a flow of the reagent ions introduced from the ion generation passage 11h to the center.

The carrier gas inlet 13 may be disposed between the ion selection part 12 and the reaction tube 3. The carrier gas inlet 13 may include a first connection tube 131, an orifice 133, and a carrier gas inlet tube 135.

The first connection tube 131 may be coupled to the ion selection part 121. The first connection tube 131 may extend in the first direction D1. The first connection tube 131 may provide a first connection passage (no reference numeral). That is, the first connection passage may be defined by the first connection tube 131. The first connection passage may extend in the first direction D1. The first connection passage may be connected to the ion selection passage. The orifice may be disposed at the first connection passage. The orifice 133 may include a portion of the cylindrical shape. The carrier gas inlet tube 135 may extend in a direction crossing the first direction D1. The carrier gas inlet tube 135 may be coupled to the first connection tube 131. The carrier gas inlet tube 135 may be connected to the carrier gas supply part Sc. The carrier gas may be moved from the carrier gas supply part Sc to the first connection tube 131 through the carrier gas inlet tube 135. The carrier gas may be mixed with the reagent ions in the first connection tube 131. The carrier gas may guide a flow of the reagent ions in the reaction tube 3. For example, the carrier gas may form a laminar flow to guide a direction of the flow of the reagent ions in the reaction tube 3. The carrier gas may include an inert gas. For example, the carrier gas may include nitrogen (N₂), argon (Ar), and/or helium (He).

The reaction tube 3 may provide a reaction passage 3h extending in the first direction D1. The reaction passage 3h may connect the upper flow path and the lower flow path. The sample inlet tube 2 may be coupled to the reaction tube 3. The sample inlet tube 2 may supply the sample gas to the reaction passage. More specifically, the sample gas may be received from the sample supply part Ss and sent to the reaction passage 3h. The main pump Pm may be connected to the reaction passage 3h through the connection tube 4. The sample gas may react with the reagent ions in the reaction passage 3h. Accordingly, at least a portion of the sample gas may be converted into the sample ions.

The lower region 5 may include a second connection tube 51, a second ion selection part 53, and an ion detection part 55.

The second connection tube 51 may be coupled to the reaction tube 3. The second connection tube 51 may connect the reaction tube 3 and the second ion selection part 53.

The second ion selection part 53 may include a second ion selection tube 531, a second quadrupole filter 533, and a second focusing member 535.

The second ion selection tube 531 may provide a second ion selection passage 531h extending in the first direction D1. The second ion selection passage 531h may be connected to the reaction passage 3h. The second turbo pump P2 may be fixed and coupled to the second ion selection tube 531. The second turbo pump P2 may apply the vacuum pressure to the second ion selection passage 531h.

The second quadrupole filter 533 may include four rods surrounding a path of the reagent ions passing through the second focusing member 535. Each of the four rods may extend in the first direction D1. Each of the four rods may include metal. Each of the four rods may receive a voltage from an external power supply (not shown). The second quadrupole filter 533 may form an electric field. A movement path of a portion or a whole of the reagent ions may be bent by the electric field formed by the second quadrupole filter 533.

The second focusing member 535 may be disposed at the second ion selection passage 531h.w The second focusing member 535 may have a plate shape having a hole formed at a center thereof. The second focusing member 535 may guide a flow of the reagent ions introduced from the reaction passage 3h to the center.

The ion detection part 55 may be coupled to the second ion selection part 53. The ion detection part 55 may include a detection tube 551 and a detector 553. The detection tube 551 may be coupled to the second ion selection tube 531. The detector 553 may be disposed in the detection tube 551. The detector 553 may be exposed to the second ion selection passage 531h. As illustrated in FIG. 2, a normal line of the detector 553 may be substantially parallel to the first direction D1. However, the embodiment of the inventive concept is not limited thereto. The normal line of the detector 553 may be inclined by a predetermined angle to the first direction D1. For example, the normal line of the detector 553 may be substantially perpendicular to the first direction D1.

The sample ions filtered in the second ion selection passage 531h may be detected by the detector 553. For example, when the normal line of the detector 553 is substantially parallel to the first direction D1, the detector 553 may measure an amount of the sample ions moving linearly without being bent by the electric field provided by the second quadrupole filter 533. That is, when the second quadrupole filter 533 is controlled so that only some ions are moved linearly, the detector 553 may measure the amount of the ions moving linearly. By using information on the electric field applied by the second quadrupole filter 533, a mass-to-charge ratio (m/z) of the ions that are moved linearly and detected by the detector 553 may be calculated. The ions to be moved linearly may be changed by controlling the second quadrupole filter 533. Thereafter, the above-described operation may be repeated. Thus, the mass-to-charge ratio (m/z) of various ions may be obtained. When measured data are compared with data of the previously secured mass-to-charge ratio (m/z), a mass and ratio of particles in the sample gas may be obtained.

Although the upper region 1, the reaction tube 3, and the lower region 5 are illustrated and described as being arranged on a straight line, the embodiment of the inventive concept is not limited thereto. That is, the reaction tube 3 may be bent as illustrated in FIG. 1.

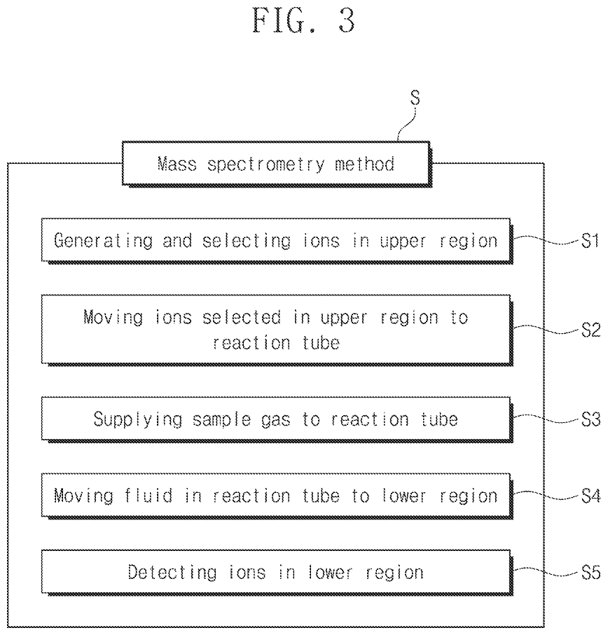

FIG. 3 is a flowchart representing a mass spectrometry method according to embodiments of the inventive concept.

Referring to FIG. 3, a mass spectrometry method S may be provided. The mass spectrometry method S may analyze a sample gas by using the mass spectrometer A (refer to FIG. 1) described with reference to FIGS. 1 to 2. To this end, the mass spectrometry method S may include: a process S1 of generating and selecting ions in an upper region; a process S2 of moving the selected ions from the upper region to a reaction tube; a process S3 of supplying a sample gas to the reaction tube; a process S4 of moving a fluid in the reaction tube to a lower region; and a process S5 of detecting ions in the lower region.

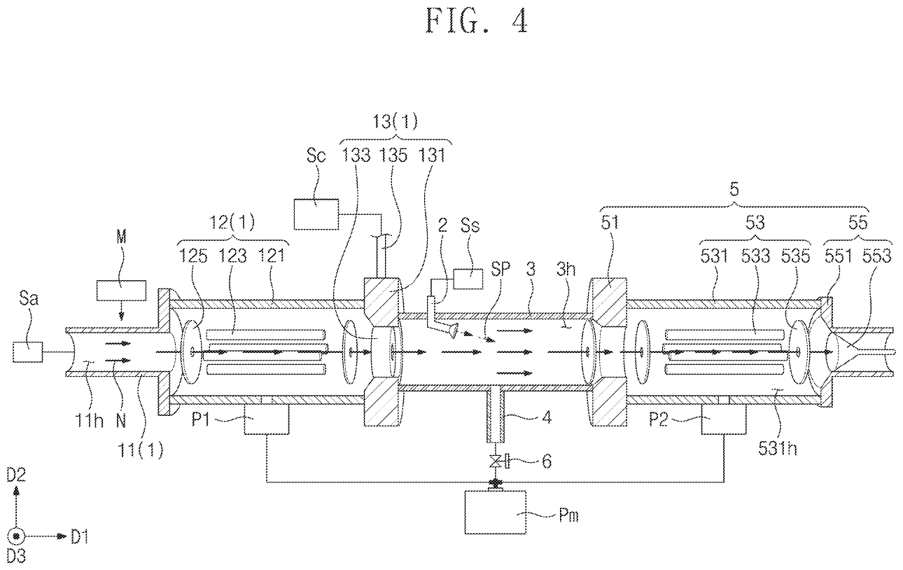

Hereinafter, the mass spectrometry method S of FIG. 3 will be described in detail with reference to FIG. 4.

FIG. 4 is a cut-away perspective view illustrating a mass spectrometer that performs the mass spectrometry method according to the flowchart of FIG. 3.

Referring to FIGS. 4 and 3, the process S1 of generating and selecting the ions in the upper region may include a process of supplying an ion source N to an ion generation part 11 by an ion source supply part Sa. At least a portion of the ion source N in the ion generation part 11 may be ionized by a microwave supply part M. Only reagent ions necessary for mass spectrometry in the fluid introduced into the ion selection part 12 may be selected through the ion selection part 12. The selected reagent ions may be moved into the reaction tube 3. In this process, the vacuum pressure may be applied to an upper region 1. More specifically, the vacuum pressure may be applied to an ion selection passage by using a main pump Pm and a first turbo pump P1.

The process S2 of moving the selected ions from the upper region to the reaction tube may include a process of applying the vacuum pressure to the reaction tube 3 by using the main pump Pm. Accordingly, a reaction passage 3h may be in a vacuum state. In this process, pressure in the reaction passage 3h may be adjusted by adjusting a regulation valve 6.

The process S3 of supplying the sample gas to the reaction tube may include a process of supplying a sample gas SP supplied from a sample supply part Ss to the reaction passage 3h through a sample inlet tube 2. The sample gas SP may react with the reagent ions in the reaction passage 3h. Accordingly, sample ions may be generated.

The process S4 of moving the fluid in the reaction tube to the lower region may include a process of applying the vacuum pressure to a lower region 5 by using a second turbo pump P2. More specifically, the vacuum pressure may be applied to a second ion selection passage by using the main pump Pm and the second turbo pump P2.

The process S5 of detecting the ions in the lower region may include a process of detecting the sample ions by a detector 553. Thus, constituents of the sample gas SP may be analyzed.

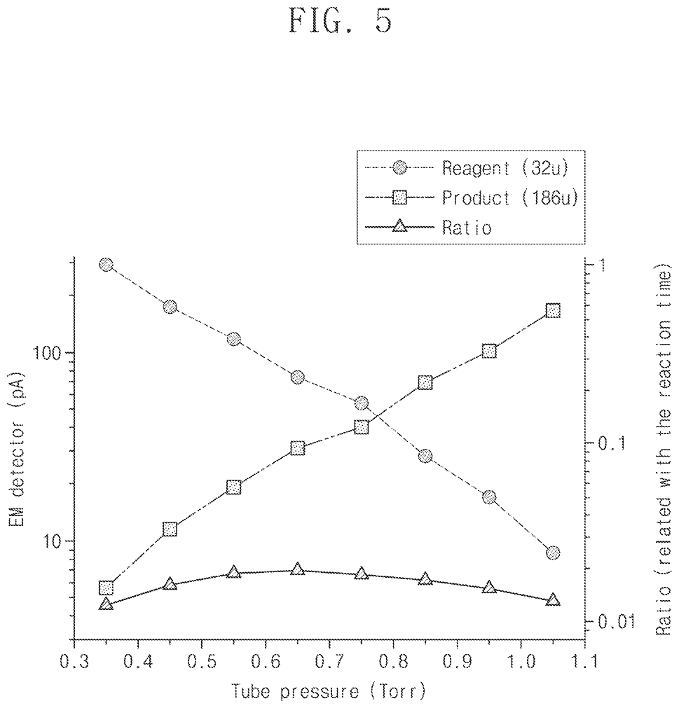

FIG. 5 is a graph showing a portion of results obtained by performing the mass spectrometry method using the mass spectrometer according to embodiments of the inventive concept.

Referring to FIG. 5, a horizontal axis may represent pressure in the reaction tube. A vertical axis may represent detected sample ions. As the pressure increases from 0.3 torr, a ratio between the reagent ions and a product may increase. When the pressure exceeds a predetermined value, the ratio may decrease again. The ratio may be maximized at a pressure of about 0.65 torr. Pressure adjustment may be performed by using a regulation valve. That is, the pressure in the reaction tube may be controlled as desired by using the regulation valve disposed between the main pump and the reaction tube.

According to the mass spectrometer and the mass spectrometry method using the same according to embodiments of the inventive concept, the pressure in the reaction tube may be arbitrarily adjusted by using the regulation valve. Accordingly, the mass spectrometry may be performed under various conditions. Also, other variables may be controlled by controlling the pressure. For example, an introduction amount of a carrier gas and a sample gas may be controlled in a state of fixing a reaction time and pressure in the reaction tube. Alternatively, the pressure and the reaction time in the reaction tube may be controlled in a state of fixing the introduction amount of the carrier gas and the sample gas. Accordingly, an optimal condition may be found.

According to the mass spectrometer and the mass spectrometry method using the same according to embodiments of the inventive concept, an additional pump for driving two turbo pump may not be required. The turbo pump may not operate properly by itself. Thus, an additional pump may be required to drive the turbo pump. According to an embodiment of the inventive concept, as the main pump is connected to each of the two turbo pumps, the two turbo pumps may be driven by using the main pump. Accordingly, the number of required total pumps may be reduced. Thus, an overall volume of an apparatus may be reduced, and costs may be saved.

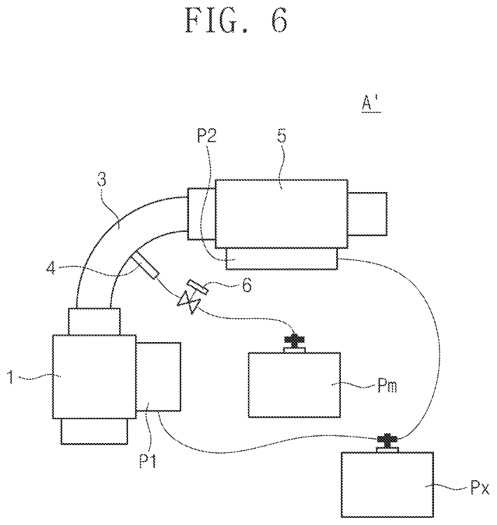

FIG. 6 is a schematic view illustrating a mass spectrometer according to embodiments of the inventive concept.

Hereinafter, features that are substantially the same as or similar to those described with reference to FIGS. 1 to 5 will be omitted.

Referring to FIG. 6, a mass spectrometer A′ may be provided. The mass spectrometer A′ of FIG. 6 may further include an auxiliary pump Px, unlike that described with reference to FIG. 1. The auxiliary pump Px may be connected to each of a first turbo pump P1 and a second turbo pump P2. The main pump Pm may not be connected to each of the first turbo pump P1 and the second turbo pump P2. The main pump Pm may be connected to the reaction tube 3 through a connection tube 4 and a regulation valve 6.

According to the mass spectrometer and the mass spectrometry method using the same, the total volume may be reduced.

According to the mass spectrometer and the mass spectrometry method using the same, the pressure may be individually controlled.

According to the mass spectrometer and the mass spectrometry method using the same, the various variables may be controlled.

The objects of the present invention are not limited to the aforementioned object, but other objects not described herein will be clearly understood by those skilled in the art from descriptions below.

Although the embodiments of the present invention have been described, it is understood that the present invention should not be limited to these embodiments but various changes and modifications can be made by one ordinary skilled in the art within the spirit and scope of the present invention as hereinafter claimed. Thus, the above-disclosed embodiments are to be considered illustrative and not restrictive.

What is claimed is:

1. A mass spectrometer comprising:
an upper region configured to provide an upper flow path;
a lower region configured to provide a lower flow path;
a reaction tube configured to provide a reaction passage configured to connect the upper flow path and the lower flow path;
a first turbo pump coupled to the upper region to apply vacuum pressure to the upper flow path;
a second turbo pump coupled to the lower region to apply the vacuum pressure to the lower flow path; and
a main pump,
wherein the main pump is connected to:
the first turbo pump and connected to the upper flow path through the first turbo pump;
the second turbo pump and connected to the lower flow path through the second turbo pump; and
the reaction passage to apply the vacuum pressure to the reaction passage.

2. The mass spectrometer of claim 1, further comprising a connection tube configured to connect the reaction tube and the main pump,
wherein the main pump is connected to the reaction passage through a connection passage provided by the connection tube.

3. The mass spectrometer of claim 2, further comprising a regulation valve disposed on the connection tube.

4. The mass spectrometer of claim 3, wherein the regulation valve comprises a solenoid valve.

5. The mass spectrometer of claim 1, wherein the upper region comprises:
an ion generation part configured to provide an ion generation passage; and
an ion selection part connected to the ion generation passage to provide an ion selection passage,
wherein the ion generation passage and the ion selection passage are a portion of the upper flow path, and
the first turbo pump is coupled to the ion selection part.

6. The mass spectrometer of claim 5, wherein the ion selection part comprises a first quadrupole filter disposed in the ion selection passage.

7. The mass spectrometer of claim 5, wherein the upper region further comprises a carrier gas inlet part disposed between the ion selection part and the reaction tube.

8. The mass spectrometer of claim 1, further comprising a sample inlet tube coupled to the reaction tube to provide a sample inlet passage connected to the reaction passage.

9. The mass spectrometer of claim 1, wherein the lower region comprises:
a second ion selection part configured to provide a second ion selection passage connected to the reaction passage; and
an ion detection part coupled to the second ion selection part,
wherein the second ion selection passage is a portion of the lower flow path, and
the second turbo pump is coupled to the second ion selection part.

10. The mass spectrometer of claim 9, wherein the ion detection part comprises an ion detector, and
the ion detector is exposed to the second ion selection passage.

11. A mass spectrometer comprising:
an ion generation part configured to provide an ion generation passage;
an ion selection part connected to the ion generation passage to provide an ion selection passage;
a reaction tube configured to provide a reaction passage connected to the ion selection passage;
a second ion selection part configured to provide a second ion selection passage connected to the reaction passage;
an ion detection part coupled to the second ion selection part;
a first turbo pump coupled to the ion selection part to apply vacuum pressure to the ion selection passage;
a second turbo pump coupled to the second ion selection part to apply the vacuum pressure to the second ion selection passage;
a main pump connected to the reaction tube to apply the vacuum pressure to the reaction passage; and
a regulation valve disposed between the reaction tube and the main pump.

12. The mass spectrometer of claim 11, further comprising a connection tube configured to connect the reaction tube and the main pump,
wherein the regulation valve is disposed on the connection tube.

13. The mass spectrometer of claim 11, wherein the regulation valve comprises a solenoid valve.

14. The mass spectrometer of claim 11, wherein the main pump is connected to the first turbo pump to apply the vacuum pressure to the ion selection passage through the first turbo pump.

15. The mass spectrometer of claim 11, wherein the main pump is connected to the second turbo pump to apply the vacuum pressure to the second ion selection passage through the second turbo pump.

16. A mass spectrometry method comprising:
generating and selecting ions in an upper region;
moving the ions selected in the upper region to a reaction tube;
supplying a sample gas to the reaction tube;
moving a fluid in the reaction tube to a lower region; and
detecting the ions in the lower region,
wherein the moving of the ions selected in the upper region to the reaction tube comprises:
applying vacuum pressure to the reaction tube by using a main pump connected to the reaction tube; and
adjusting pressure of the reaction tube by using a regulation valve disposed between the reaction tube and the main pump.

17. The mass spectrometry method of claim 16, wherein the generating and selecting of the ions in the upper region comprises applying the vacuum pressure to the upper region by using a first turbo pump, and
the first turbo pump is connected to the main pump.

18. The mass spectrometry method of claim 16, wherein the moving of the fluid in the reaction tube to the lower region comprises applying the vacuum pressure to the lower region by using a second turbo pump, and
the second turbo pump is connected to the main pump.
